(19) United States
(12) Patent Application Publication
(10) Pub. No.: US 2005/0105748 A1
(43) Pub. Date: May 19, 2005

(54) Integrated flexible display and speaker apparatus and method

(75) Inventor: Don G. Bartell, Wheaton, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/714,233

(22) Filed: Nov. 14, 2003

(51) Int. Cl. H04R 5/02; H04R 1/02; H04R 9/06

(52) U.S. Cl. 381/306; 381/333; 381/388

(57) ABSTRACT

A flexible substrate (21) can support both a flexible active display (31) and a flexible audio transducer (22). When not in use the flexible substrate can be reconfigured into a non-deployed form factor. For example, the flexible substrate (and hence the corresponding display and audio transducer) can be folded or rolled up to permit compact storage of same. Multiple flexible audio transducers can be provided in this fashion. If desired, an acoustic damper (71) can be employed to acoustically isolate the audio transducer from the display.

### TECHNICAL FIELD

This invention relates generally to integrated display and speaker apparatus.

### BACKGROUND

Various devices known in the prior art have both a display and a corresponding audio transducer. For example, a television receiver typically has both a display and one or more speakers. More recently other devices, such as cellular-style telephones, have begun to include both an integrated video display and an audio transducer.

Unfortunately, such interfaces are not infinitely scalable with respect to practical human usage. At some point, a given display can be too small to be of any practical use. This point can be a function of the limits of human perception, the quantity of information to be displayed at any given time on the display, or both. Such limits represent a significant challenge as products such as cellular telephones, personal digital assistants, small personal computers and the like both shrink in size while gaining increased functionality and/or networking capability.

In general, both the display and the speaker comprise essentially rigid structures (notwithstanding that a portion of a speaker will typically have some flexibility to permit vibration and hence generation of an audible signal). Alternative embodiments exist, however. For example, non-rigid displays comprised of organic light emitting diodes are known while non-rigid speakers formed of dielectric elastomer polymer material also represent a known development. While such proposals comprise an alternative to more commonplace rigid construction, such embodiments have, to date, found little useful application with respect to addressing the needs expressed above.

### BRIEF DESCRIPTION OF THE DRAWINGS

The above needs are at least partially met through provision of the integrated flexible display and speaker apparatus and method described in the following detailed description, particularly when studied in conjunction with the drawings, wherein:

FIG. 1 comprises a perspective view of an integrated flexible display and speaker apparatus as configured in accordance with various embodiments of the invention;

FIG. 2 comprises a perspective view of the integrated flexible display and speaker apparatus of FIG. 1 as the speaker is exposed in accordance with an embodiment of the invention;

FIG. 3 comprises a perspective view of the integrated flexible display and speaker apparatus of FIG. 1 as the display and speaker are fully exposed in accordance with an embodiment of the invention;

FIG. 4 comprises a schematic side elevational detail depiction of a flexible speaker as configured in accordance with an embodiment of the invention;

FIG. 5 comprises a front elevational view of an integrated flexible display and speaker apparatus as configured in accordance with another embodiment of the invention;

FIG. 6 comprises a front elevational view of an integrated flexible display and speaker apparatus as configured in accordance with yet another embodiment of the invention;

FIG. 7 comprises a front elevational view of an integrated flexible display and speaker apparatus as configured in accordance with yet another embodiment of the invention; and

FIG. 8 comprises a front elevational cutaway detail view of an integrated flexible display and speaker apparatus as configured in accordance with yet another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, an integrated display and speaker comprises a flexible active display and a flexible audio transducer proximally disposed with respect to the flexible active display. Pursuant to one embodiment both the display and the speaker share a common flexible substrate. Pursuant to another embodiment, a first flexible substrate supports the flexible active display and a second flexible substrate supports the flexible audio transducer. In a preferred approach, an acoustic damper operably couples between such a first and second flexible substrate.

So configured, such an apparatus can be disposed in a substantially planar form factor to permit use. Following use, however, the integrated display and speaker can be selectively disposed in a non-planar form factor to permit storage. For example, pursuant to one embodiment the integrated display and speaker, being flexible, can be folded. Pursuant to another embodiment, the apparatus can be formed into a substantially rolled, cylindrical shape. Pursuant to a preferred approach, the apparatus can be retractably disposed within a housing such as a personal digital assistant housing, a cellular-style telephone housing, or a pen-like structure, to name a few. This, in turn, permits many relatively small devices to have a display and speaker assembly of useful size. By deploying the flexible display/speaker assembly during use and then exploiting that flexibility to permit storage in a more constrained fashion, this apparatus resolves many of the issues and concerns that have beset and frustrated, to date, the design of useful yet compact personal devices.

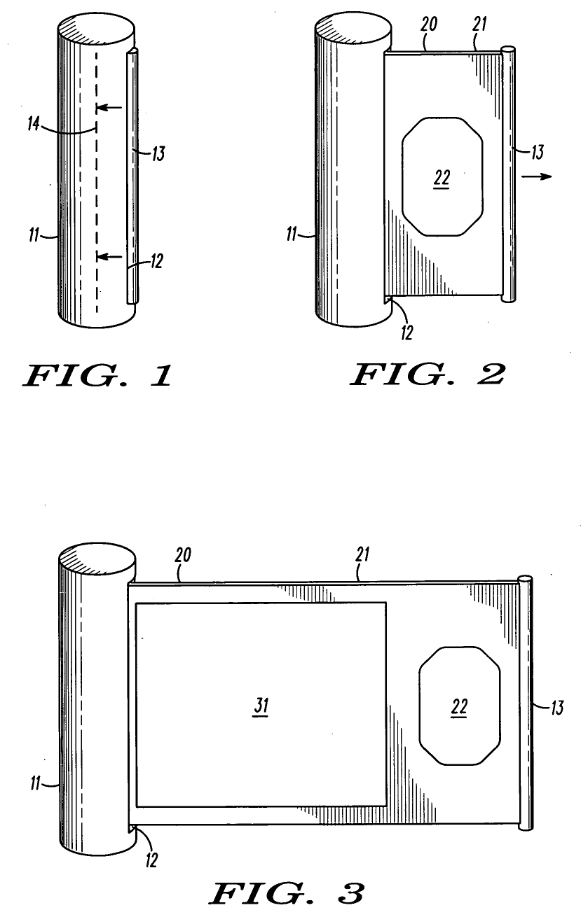

Referring now to the drawings, and in particular to FIG. 1, an illustrative embodiment will be described. In this illustrative embodiment, a housing 11 comprises a cylindrically-shaped hollow member having a slot 12 formed longitudinally along a side thereof A hand-graspable tab 13 extends outwardly of this slot 12. The relative sizes of these elements can vary with the needs and dictates of a particular application. The housing 11 has a retraction mechanism 14 disposed therein, such as a spring biased retraction mechanism, a mechanical wind-up mechanism, or a motor-powered retraction mechanism, to name a few. Such retraction mechanisms are well understood in the art and therefore no additional detail will be provided here for the sake of brevity and the preservation of focus.

Referring now to FIG. 2, an integrated display and speaker apparatus 20 will begin to be exposed as the graspable tab 13 is urged laterally away from the housing 11. In particular, the tab 13 couples to a flexible substrate 21 (such as a sturdy and resilient base film comprised of Kapton or some other similar material having like properties and flexibility) and therefore permits the flexible substrate 21 to be withdrawn from the housing 11 in opposition to whatever biasing force might be present due to the retraction mechanism 14 as the tab 13 is urged away from the housing 11. In this particular embodiment, a flexible speaker 22 becomes exposed first during this withdrawal process with the flexible speaker 22 being formed on and supported by the flexible substrate 21.

Referring now to FIG. 3, continued withdrawal of the flexible substrate 21 eventually reaches a conclusion when the flexible substrate 21 reaches a fully-withdrawn limit. In this embodiment, at this point, both the flexible speaker 22 and a flexible active display 23 are fully exposed. The flexible active display 23 can comprise, for example, an array of organic light emitting diodes that are formed on the flexible substrate 31. Such active displays are known in the art and hence further details and elaboration regarding such displays will not be provided here for the sake of brevity and clarity.

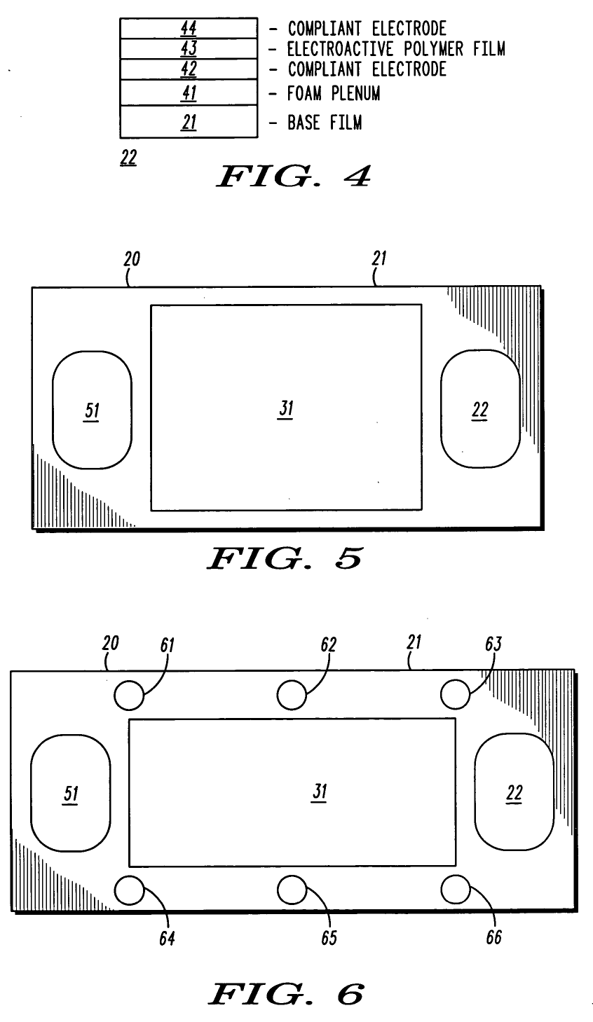

Referring now to FIG. 4, the flexible speaker 22 can be realized through provision of an elastomeric dielectric polymer film sonic actuator. Such actuators are known in the art and can comprise, as illustrated, a laminated structure that includes an electroactive polymer film 43 having a compliant electrode 42 and 43 disposed on either side thereof that rests upon a foam plenum 41 that couples to a base film such as the flexible substrate 21. A speaker comprised in this fashion is lightweight and has a relatively low vertical profile (in general, such speakers are essentially flat and thin). Notwithstanding such form factors, such speakers also tend to be capable of relatively high acoustic power emissions. As further benefits, such speakers are relatively easy to manufacture and employ relatively low cost materials.

A typical prior art embodiment employing such a speaker tends to exploit the conformal flat nature of the speaker by conformably disposing the speaker over, for example, a curved surface. In the present embodiments, however, the applicant exploits and employs the flexible nature of these speakers. In particular, such a speaker can be suitably formed on a flexible substrate that also hosts a flexible display (such as the organic light emitting diode array noted above). Such a speaker will exhibit a vertical profile that is comparable to, or less than, the vertical profile of the display. This, in turn, facilitates the ease of fabricating an integrated flexible display/speaker apparatus as described above.

It will be understood by those skilled in the art that the embodiments set forth above are illustrative of these essential concepts and do not comprise an exhaustive representation of all potential embodiments. For example, and referring now to FIG. 5, the integrated display and speaker apparatus 20 can further include a second flexible speaker 51 if desired. As illustrated, this second flexible speaker 51 can be on an opposite side of the display 31 with respect to the first flexible speaker 22. So configured, stereo audio content can be readily provided to a user of the apparatus 20. As another example, and referring now to FIG. 6, an even greater number of flexible speakers (61 through 66 in this illustrative example) can be formed on the flexible substrate 21. These various flexible speakers can be sized and positioned to suit the needs of a given application. As one example, the flexible speakers can be disposed substantially equidistant from one another about the flexible active display. As yet another example, such an apparatus can host more than one discrete active flexible display (not shown) in combination with one or more flexible speakers.

Such displays and speakers of course are intended to serve as an output interface mechanism to provide corresponding visual and auditory content to a user. Such content can be sourced in a variety of known conventional ways. These include, but are not limited to, received media content (as received via a wireline and/or a wireless communication path), media content as is stored on a removable media storage device (such as a readable disc, a random access memory, or other suitable mechanism), and/or locally stored media content, all as is well understood in the art. The interface to such media content, and the appropriate or necessary driver circuitry, can be positioned and disposed as appropriate to the needs and limitations of a given application. For example, the media content interface can be disposed within the housing 11, the graspable tab 13, and/or on the flexible substrate 21 itself In a similar manner, user control interface mechanisms can be provided as well. For example, volume control, muting, brightness adjustment, and the like can be accomplished in various known ways by placing corresponding controls where and as appropriate.

Speakers produce sound through vibration. Such vibration may be of sufficient magnitude (and/or of a particularly troublesome resonant frequency) as to potentially interfere with the operation of the display in such an embodiment. For example, the vibrations of the speaker 22 may be sufficient, at least from time to time, to cause undesired intermittent or prolonged interference with the operation and/or viewability of the display. In one embodiment, and referring now to FIG. 7, an acoustic damper 71 can be disposed between a first flexible substrate 72 that supports the flexible display 31 and a second flexible substrate 73 that supports the flexible speaker 22.

Such an acoustic damper 71 can serve to dampen or fully attenuate acoustic energy as generated by the speaker 22 to thereby mitigate or prevent any such interference with the operability of the display 31. Such an acoustic damper 71 can be realized through use of a variety of materials. For example, the acoustic damper 71 can comprise a material having one of more vacuums formed therein that are disposed to at least partially attenuate a transfer of acoustic energy from the speaker 22 to the first flexible substrate 72 and the display 31 supported thereby. As another example, the acoustic damper 71 can comprise a discontinuous material, such as a material characterized by a woven structure and/or a material having a plurality of holes disposed therethrough. Again, such a material will serve, at least in part, to dampen the transfer of acoustic energy there-across.

When using such an acoustic damper 71, the first and second flexible substrates 72 and 73 can be comprised of a similar material or of differing materials as may best suit the requirements of a given embodiment and application. It will also be appreciated that multiple acoustic dampers may be consecutively and/or contiguously employed to increase a degree of resultant acoustic dampening as between a source of acoustic energy and such a display and/or that a plurality of such acoustic dampers may be utilized to isolate a plurality of flexible speakers from one or more flexible displays as comprise an integrated display and speaker apparatus.

In general, such flexible speakers will perform more optimally when the underlying base film is relatively taut. Such a condition can result when a user holds the flexible substrate 21 under tension after deploying the flexible substrate 21 as described above. Such a requirement may not be suitable or practical for all intended uses and applications, however. It may therefore be desired to employ a selective rigidizer.

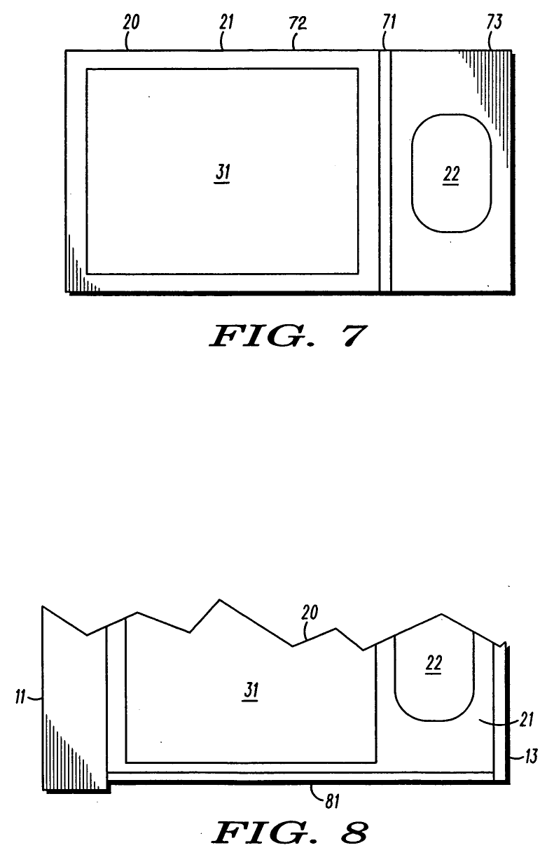

For example, and referring now to FIG. 8, a selective rigidizer comprising a support rod 81 can be disposed (for example, upon being lodged in corresponding and opposing pilot holes (not shown) as may be provided on both the housing 11 and the tab 13) between the housing 11 and the graspable tab 13 upon fully deploying the flexible substrate 21 to hold the flexible substrate 21 under suitable tension. It will usually be preferred to ensure that such a selective rigidizer is disposed sufficiently proximal to the flexible speaker 22 to aid in ensuring the taut nature of the flexible speaker 22 itself.

As another example, when the overall embodiment facilitates folding of the overall structure (as versus, for example, rolling of the structure into a cylindrical shape), a rigid backing surface and material can be employed at least behind the speaker and/or speaker area to again provide a desired level of tautness. For example, and referring again to FIG. 7, the substrate 73 behind the audio transducer 22 can comprise a rigid material. So configured, the latter can be folded over against the display portion of the structure and the audio transducer 22 can be provided with a desired level of tautness as per the rigid material.

Such embodiments permit provision of an integrated display and speaker having a flexible display that comprises an active display on a conformably flexible display surface and a flexible speaker (or speakers) that is integrally configured with respect to the flexible display for selectively providing audible sound. When deployed a user can use this structure to view a visual presentation and to hear a corresponding audio presentation. A suitable retraction mechanism can then be used to permit reconfiguration of the display and speaker(s) to thereby better facilitate storage of the display and speaker(s) within the form factor of the overall apparatus or device. Such embodiments can be realized with available technologies and yet are likely to remain compatible for use with methods and materials developed hereafter.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. An apparatus comprising:
a flexible substrate;
a flexible active display supported by the flexible substrate;
a flexible audio transducer proximally disposed with respect to the flexible active display and also supported by the flexible substrate;
an acoustic dampener operably coupled between the flexible active display and the flexible audio transducer.

2. (canceled)

3. The apparatus of claim 1 further comprising at least a second flexible audio transducer proximally disposed with respect to the flexible active display.

4. The apparatus of claim 3 wherein the flexible substrate that supports the flexible active display and the flexible audio transducer also supports the at least a second flexible audio transducer.

5. The apparatus of claim 1 further comprising a plurality of flexible audio transducers disposed substantially equidistant from one another about the flexible active display.

6. The apparatus of claim 1 further comprising:
a first flexible substrate that supports the flexible active display;
a second flexible substrate that supports the flexible audio transducer.

7. (canceled)

8. The apparatus of claim 1 wherein the acoustic dampener includes a vacuum disposed therein.

9. The apparatus of claim 1 wherein the acoustic dampener comprises a discontinuous material.

10. The apparatus of claim 9 wherein the discontinuous material comprises a woven structure.

11. The apparatus of claim 9 wherein the discontinuous material includes a plurality of holes disposed through the material.

12. The apparatus of claim 6 wherein the first and second flexible substrate are comprised of a similar material.

13. The apparatus of claim 6 wherein the first and second flexible substrate are comprised of differing materials.

14. The apparatus of claim 1 wherein the flexible audio transducer is comprised of at least one layer of a dielectric elastomer polymer material.

15. The apparatus of claim 14 wherein the at least one layer of a dielectric elastomer polymer material has a compliant electrode material disposed on at least one side thereof.

16. The apparatus of claim 15 wherein the at least one layer of a dielectric elastomer polymer material has a compliant electrode material disposed on both of opposing sides thereof.

17. The apparatus of claim 1 further comprising a selective rigidizer disposed proximal to the flexible audio transducer.

18. The apparatus of claim 1 further comprising a rigid backing disposed at least partially coextensively with the flexible audio transducer.

19. The apparatus of claim 1 further comprising a housing and a retraction mechanism disposed therein that is operably coupled to the flexible active display and the flexible audio transducer.

20. A method of forming a flexible combined display and speaker apparatus, comprising:
providing a flexible substrate;
supporting a flexible active display with the flexible substrate;
supporting a flexible speaker with the flexible substrates
disposing an acoustic dampener between the flexible active display and the flexible speaker.

21. The method of claim 20 further comprising:
temporarily disposing the flexible substrate, and hence the flexible active display and the flexible speaker, in a non-planar configuration.

22. The method of claim 21 wherein temporarily disposing the flexible substrate, and hence the flexible active display and the flexible speaker, in a non-planar configuration comprises rolling the flexible substrate, and hence the flexible active display and the flexible speaker, into a substantially cylindrical shape.

23. The method of claim 22 further comprising:
retractably disposing at least a portion of the substantially cylindrical shape into a housing.

24. The method of claim 21 wherein temporarily disposing the flexible substrate, and hence the flexible active display and the flexible speaker, in a non-planar configuration comprises folding the flexible substrate.

25. An integrated display and speaker comprising:
flexible display means for selectively providing an active display on a conformably flexible display surface;
flexible speaker means integrally configured with respect to the flexible display means for selectively providing audible sound;
acoustic dampening means operably and integrally coupled between the flexible display means and the flexible speaker means.

26. The integrated display and speaker of claim 25 wherein the flexible speaker means comprises a dielectric elastomer polymer.

27. The integrated display and speaker of claim 26 wherein the dielectric elastomer polymer has a compliant electrode material disposed on at least one side thereof.

28. The integrated display and speaker of claim 27 wherein the dielectric elastomer polymer has a compliant electrode material disposed on at least two opposing sides thereof.

29. The integrated display and speaker of claim 28
wherein the compliant electrode material on both sides of the dielectric elastomer polymer comprises a substantially identical material.

30. The apparatus of claim 1 further comprising a plurality of flexible audio transducers proximally disposed with respect to the flexible active display and supported by the flexible active display, wherein at least two of the flexible audio transducers comprise speakers.
